(19) United States
(12) Patent Application Publication
(10) Pub. No.: US 2003/0058281 A1
(43) Pub. Date: Mar. 27, 2003

(54) Method, apparatus and computer program product for implementing transparent scrollbars

(75) Inventors: Kevin Peter Kepros, Pine Island, MN (US); Michael R. Lenz, Rochester, MN (US); Nathan J. Rauh, Rochester, MN (US); Rick William Stuart, Rochester, MN (US)

Correspondence Address: James R. Nock, IBM Corporation - Dept. 917, 3605 Highway 52 North, Rochester, MN, 55901, US

(73) Assignee: INTERNATIONAL BUSINESS MACHINES CORPORATION

(21) Appl. No.: 09/907,221

(22) Filed: Jul. 17, 2001

(51) Int. Cl. G06F 3/14

(52) U.S. Cl. 345/786

(57) ABSTRACT

A method, apparatus and computer program product are provided for implementing transparent scrollbars in a display. Transparent scrollbars on a user interface display screen in a computer system are implemented with a selected area of the user interface display screen defined as a scrollbar. A document is drawn in a window area including the selected area of the user interface display screen defined as the scrollbar. Predefined scrollbar elements are drawn within the selected area of the user interface display screen. The document is visible within a portion of the selected area of the user interface display screen where the predefined scrollbar elements are not drawn. The portion of the selected area of the user interface display screen where the predefined scrollbar elements are not drawn is the largest portion of the scrollbar. This portion provides useful information of the document drawn in the window area to the user, while the scrollbar functionality is unchanged.

### FIELD OF THE INVENTION

The present invention relates generally to the data processing field, and more particularly, relates to a method, apparatus and computer program product for implementing transparent scrollbars in a display of a computer system.

### DESCRIPTION OF THE RELATED ART

When a user looks at a typical windows application, the space taken up by vertical and horizontal scrollbars includes a sizeable portion of the screen, especially for smaller monitors. For example, assuming scrollbar width of 15 pixels and a 400×600 pixel application window displayed on a 600×800 resolution monitor, the scrollbar takes up over 6% of the application window.

The problem is magnified when an application window is split into multiple frames, each containing their own scrollbars. For smaller frames, the scrollbar may routinely use 15-20% of the frame, and in some cases as much as 30%. Typically the largest portion of the scrollbars is the light grey background between the arrows at both ends. This light grey background is essentially wasted space. This portion of the scrollbar provides no useful information to the user.

A need exists for a mechanism that is effective to reduce the amount of space needed to display scrollbars in a user-friendly manner. It is also desirable to provide such a mechanism that effectively reduces the space needed to display scrollbars without interfering with the operation of scrollbars.

### SUMMARY OF THE INVENTION

A principal object of the present invention is to provide a method, apparatus and computer program product for implementing transparent scrollbars in a display. Other important objects of the present invention are to provide such method, apparatus and computer program product for implementing transparent scrollbars substantially without negative effect and that overcome many of the disadvantages of prior art arrangements.

In brief, a method, apparatus and computer program product are provided for implementing transparent scrollbars in a display. Transparent scrollbars on a user interface display screen in a computer system are implemented with a selected area of the user interface display screen defined as a scrollbar. A document is drawn in a window area including the selected area of the user interface display screen defined as the scrollbar. Predefined scrollbar elements are drawn within the selected area of the user interface display screen. The document is visible within a portion of the selected area of the user interface display screen where the predefined scrollbar elements are not drawn.

In accordance with features of the invention, the portion of the selected area of the user interface display screen where the predefined scrollbar elements are not drawn is the largest portion of the scrollbar. This portion provides useful information of the document drawn in the window area to the user, while the scrollbar functionality is unchanged.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B are block diagrams illustrating a computer system for implementing transparent scrollbars in a display in accordance with the preferred embodiment;

FIG. 1C is a diagram illustrating an exemplary display with transparent scrollbars in accordance with the preferred embodiment;

FIGS. 2A and 2B are flow charts illustrating exemplary steps for implementing transparent scrollbars in a display in accordance with the preferred embodiment;

FIG. 3 is a block diagram illustrating a computer program product in accordance with the preferred embodiment.

### DETAILED DESCRIPTION OF THE PREFERRED EMBODIMENTS

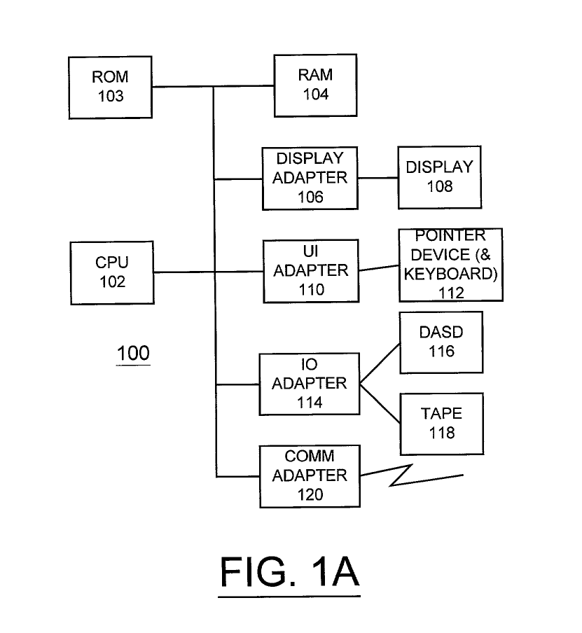

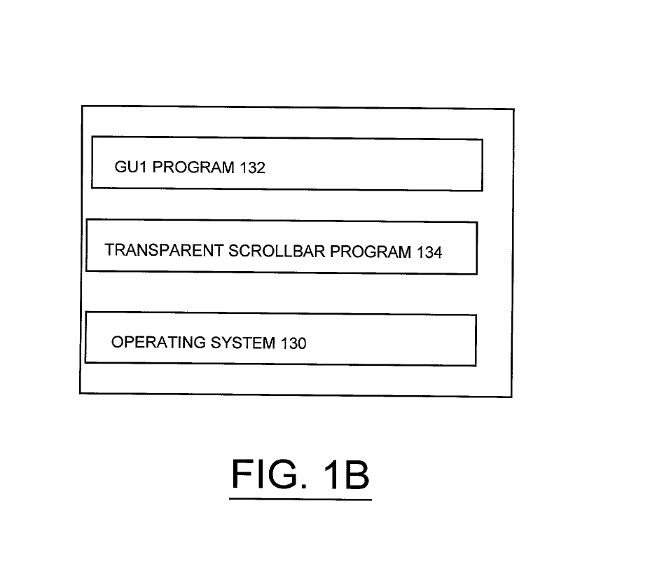

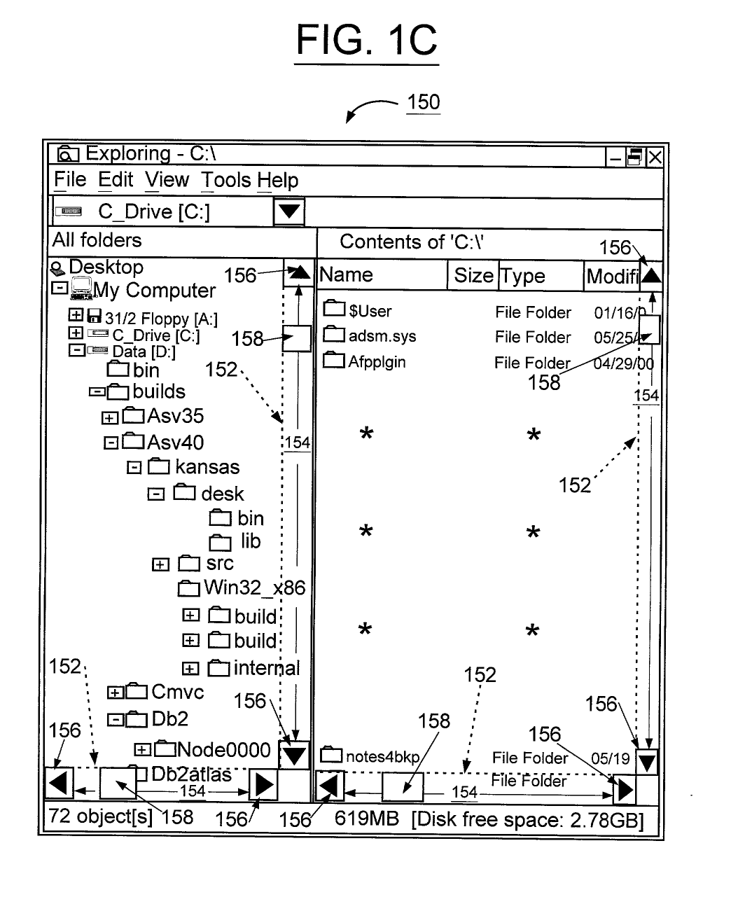

Having reference now to the drawings, in FIGS. 1A and 1B, there is shown a computer or data processing system generally designated by the reference character 100 for carrying out the transparent scrollbar methods of the preferred embodiment. As shown in FIG. 1A, computer system 100 includes a central processor unit (CPU) 102, a read only memory 103, a random access memory 104, a display adapter 106 coupled to a display 108. CPU 102 is connected to a user interface (UI) adapter 110 connected to a pointer device and keyboard 112. CPU 102 is connected to an input/output (IO) adapter 114 connected to a direct access storage device (DASD) 116 and a tape unit 118. CPU 102 is connected to a communications adapter 120 providing a communications function. It should be understood that the present invention is not limited to a computer model with a single CPU, or other single component architectures as shown in FIG. 1A.

As shown in FIG. 1B, computer system 100 includes an operating system 130, a graphical user interface (GUI) program 132 and a transparent scrollbar program 134 of the preferred embodiment. The GUI program 132 includes various computer programs that generate display screens.

In accordance with features of the preferred embodiment, transparent scrollbar program 134 of the preferred embodiment enables the user to see useful information where conventionally there would be useless gray area of a scrollbar. Transparent scrollbar program 134 provides identical scrollbar functionality as conventional scrollbars.

Referring now to FIG. 1C, an exemplary user display screen generally designated by the reference character 150 in the computer system 100 is illustrated. As shown in FIG. 1C, display 150 includes multiple scrollbars indicated by dotted lines and generally designated by the reference character 152. In accordance with features of the preferred embodiment, each of the multiple scrollbars 152 includes a transparent portion indicated by arrows designated by the reference character 154 extending between a pair of scrollbar arrows 156 at the ends of the scrollbar. Transparent scrollbar portion 154 provides identical scrollbar functionality as conventional scrollbars so that clicking in this area scrolls the window one page.

In conventional arrangement the transparent portion 154 of the scrollbar 152 is typically a light grey background. These light grey background areas of conventional arrangements are essentially wasted space, providing no useful information to the user.

In accordance with features of the preferred embodiment, the transparent portion 154 of the preferred embodiment provides useful information for user viewing, while providing identical in functionality. By making this area 154 of the scrollbar 152 transparent so that the user can see beneath this section of the scrollbar to application information or document that would normally be displayed in the window or frame if there were not scrollbars, a sizeable portion of the window/frame for the actual application is reclaimed, freeing the user from unnecessary clutter. Scrollbar active area indicators 158 also can be substantially transparent. Scrollbar active area indicators or scrollers 158 should not be completely transparent, or it would make it impossible to use the scrollbar. Instead, for example, the middle is transparent, but the outer edges are drawn in order to indicate the position of the scroller 158.

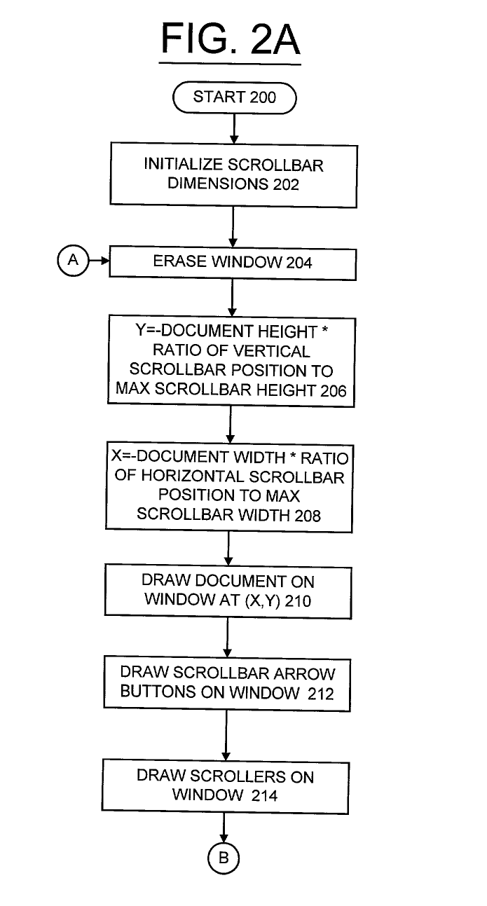

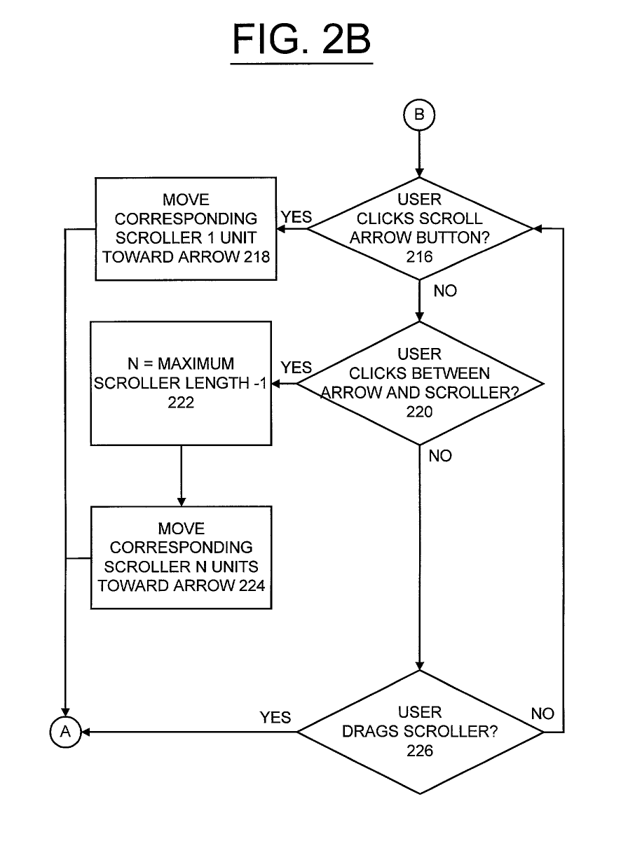

Various commercially available computers can be used for computer system 100; for example, an IBM personal computer. CPU 102 is suitably programmed by the acronym assistance program 134 to generate a display with transparent scrollbars in accordance with the preferred embodiment as illustrated in FIG. 1C and to execute the flowcharts of FIGS. 2A and 2B.

Referring now to FIGS. 2A and 2B, there are shown exemplary steps for implementing transparent scrollbars in a display in accordance with the preferred embodiment starting at a block 200. Scrollbar dimensions are initialized as indicated in a block 202. Next the display window is erased as indicated in a block 204. Next a window height variable y is calculated equal to −document height times a ratio of vertical scrollbar position to a maximum scrollbar height as indicated in a block 206. Then a window variable x is calculated equal to −document width times a ratio of horizontal scrollbar position to a maximum scrollbar width as indicated in a block 208. The document is drawn on the window at (x, y) as indicated in a block 210. The document is drawn at block 210 to cover the entire window. The scrollbar arrow buttons 156 are drawn on the window as indicated in a block 212. Scrollers 158 are drawn on the window as indicated in a block 214. The scrollbar arrow buttons 156 and scrollers 158 are drawn over the document in separate pieces at blocks 214 and 216 so that the document is visible where nothing is drawn. The sequential operations continue following entry point B in FIG. 2B.

Referring to FIG. 2B, checking for user clicks on scroll arrow button is performed as indicated in a decision block 216. When user clicks on scroll arrow button are found, then the corresponding scroller is moved 1 unit toward arrow as indicated in a block 218. Then the sequential operations continue following entry point A in FIG. 2A at block 204. When user clicks on scroll arrow button are not found, then checking for user clicks between a scrollbar arrow 156 and scroller 158 is performed as indicated in a decision block 220. When user clicks between a scrollbar arrow 156 and scroller 158 are found, then a window page variable N is set to a maximum scroller length minus one as indicated in a block I as indicated in a block 222. Then the corresponding scroller is moved N units toward the scrollbar arrow 156 as indicated in a block 224. Then the sequential operations continue following entry point A in FIG. 2A at block 204. Otherwise when user clicks between a scrollbar arrow 156 and scroller 158 are not found, then checking for the user dragging the scroller 158 is performed as indicated in a decision block 226. When the user dragging the scroller 158 is not found, then the sequential operations return to decision block 216 to check for user clicks on scroll arrow button. When the user dragging the scroller 158 is found, then the sequential operations return to block 204 following entry point A in FIG. 2A to erase the display window and continue.

An exemplary code in Java for implementing transparent scrollbars of the preferred embodiment in the system 100 follows.

import java.awt.*;
import java.awt.event.*;
import java.awt.image.*;
public class TransparentScrollBars extends Canvas
{

int hDocument, wDocument, hViewable, wViewable, dScroller,

hVScrollerMax, hVScroller,

yUnitScroll, yPageScroll, yVScroller, yVScrollerMax, yToTop;
boolean scrolling = false;
BufferedImage img, upArrow, downArrow;
public TransparentScrollBars(BufferedImage img,
int wView, int hView, int

wDoc, int hDoc)

{
this.img = img;
setSize(wView, hView);
hDocument = hDoc;
wDocument = wDoc;
hViewable = hView;
wViewable = wView;
dScroller = 16
hVScrollerMax = hViewable − 2*dScroller;
hVScroller = hVScrollerMax * hViewable/hDocument;
yUnitScroll = 1;
yPageScroll = hVScroller − yUnitScroll;
yVScroller = dScroller;
yVScrollerMax = hVScrollerMax − hVScroller + dScroller;
upArrow = new BufferedImage(dScroller, dScroller,
BufferedImage.TYPE_3BYTE_BGR);
downArrow = new BufferedImage(dScroller, dScroller,
BufferedImage.TYPE_3BYTE_BGR);
drawButton(upArrow.getGraphics( ), 1);
drawButton(downArrow.getGraphics( ), −1);
this.addMouseListener(new MouseListener( )
{
public void mouseClicked(MouseEvent ev) { }
public void mouse Entered(MouseEvent ev) { }
public void mouseExited(MouseEvent ev) {scrolling = false;}
public void mouseReleased(MouseEvent ev) {scrolling = false;}
public void mousePressed(MouseEvent ev)
{
int x = ev.getX( );
int y = ev.getY( );
if (x < wViewable − dScroller) return;
if (y < dScroller) scrollBy(0, −yUnitScroll);
else if (y < yVScroller) scrollBy(0, −yPageScroll);
else if (y < yVScroller + hVScroller) startScrolling(x, y);
else if (y < dScroller + hVScrollerMax) scrollBy(0, yPageScroll);
else scrollBy(0, yUnitScroll);
}

});
this.addMouseMotionListener(new MouseMotionListener( )

{
public void mouseMoved(MouseEvent ev) { }
public void mouseDragged(MouseEvent ev)
{
if (!scrolling) return;
yVScroller = ev.getY( ) − yToTop;
repaint( );
}
});

}
protected void scrollBy(int x, int y)
{

yVScroller += y;
repaint( );

}
protected void startScrolling(int x, int y)
{

scrolling = true;
yToTop = y − yVScroller;

}
protected void checkBounds( )
{

if (yVScroller < dScroller) yVScroller = dScroller;
else if (yVScroller > yVScrollerMax) yVScroller = yVScrollerMax;

}
public void paint(Graphics g)
{

checkBounds( );
int xlmg = 0;
int ylmg = hDocument * (yVScroller − dScroller)/hVScrollerMax;
g.drawImage(img, −xlmg, −ylmg, null);
g.drawImage(upArrow, wViewable − dScroller, 0, null);
g.drawImage(downArrow, wViewable − dScroller,
hViewable − dScroller,

null);

g.setColor(Color.gray);
g.drawRect(wViewable − dScroller, yVScroller + 1, dScroller − 2,

hVScroller − 2);
}
protected void drawButton(Graphics g, int dir)
{

int d = dScroller;
// draw the border
g.setColor(Color.black);
g.drawRect(0, 0, d, d);
g.setColor(Color.lightGray);
g.drawRect(0, 0, d-1, d-1);
g.setColor(Color.gray);
g.drawRect(1, 1, d-2, d-2);
g.setColor(Color.white);
g.drawRect(1, 1, d-3, d-3);
g.setColor(Color.lightGray);
g.fillRect(2, 2, d-3, d-3);
// draw the arrow
int cx = d/2, cy = d/2;
int[ ]xPts = new int[ ] {cx, cx−3, cx+3};
int[ ] yPts = new int[ ]{cy−2*dir, cy+dir, cy+dir};
g.setColor(Color.black);
g.drawPolygon(xPts, yPts, 3);
g.fillPolygon(xPts, yPts, 3);

}
public static void main(String[ ] args)
{
BufferedImage img = new BufferedImage(300, 900,
BufferedImage.TYPE_3BYTE_BGR);

```
Graphics g = img.getGraphics( );
g.setColor(Color.white);
g.fillRect(0, 0, 300, 900);
for(int i = 1; i < 20; i++)
{
g.setColor(new Color(i*10, i*i*i%255 i*i*i*i%255));
g.fillRect(5, i*40, 290, 20);
}
Frame f = new Frame(“Transparent ScrollBars Example”);
f.addWindowListener(new WindowAdapter( )
{
public void windowClosing(WindowEvent ev)
{
System.exit(0);
  }
});
f.add(new TransparentScrollBars(img, 300, 300, 300, 900));
f.setSize(300, 300);
f.setResizable(false);
f.pack( );
f.setVisible(true);
  }
}
```

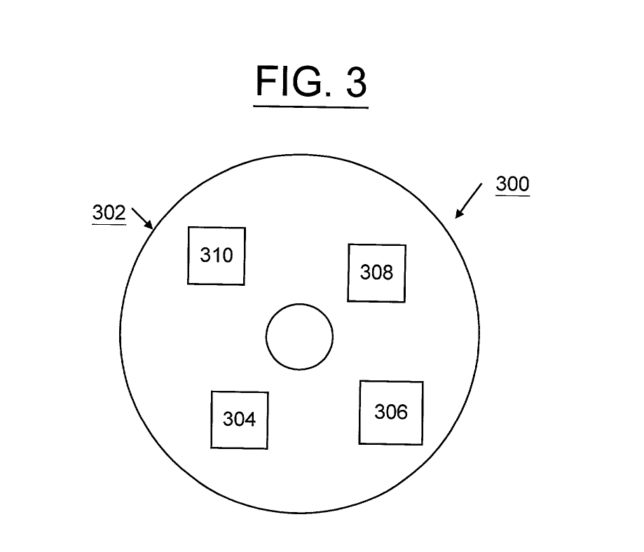

Referring now to FIG. 3, an article of manufacture or a computer program product 300 of the invention is illustrated. The computer program product 300 includes a recording medium 302, such as, a floppy disk, a high capacity read only memory in the form of an optically read compact disk or CD-ROM, a tape, a transmission type media such as a digital or analog communications link, or a similar computer program product. Recording medium 302 stores program means 304, 306, 308, 310 on the medium 302 for carrying out the methods for implementing transparent scrollbars of the preferred embodiment in the system 100 of FIG. 1.

A sequence of program instructions or a logical assembly of one or more interrelated modules defined by the recorded program means 304, 306, 308, 310, direct the computer system 100 for implementing transparent scrollbars of the preferred embodiment.

While the present invention has been described with reference to the details of the embodiments of the invention shown in the drawing, these details are not intended to limit the scope of the invention as claimed in the appended claims.

What is claimed is:

1. A method for implementing transparent scrollbars on a user interface display screen in a computer system comprising the steps of:
defining a selected area of the user interface display screen as a scrollbar;
drawing a document in a defined window area including said selected area of the user interface display screen; and
drawing predefined scrollbar elements within said selected area of the user interface display screen, whereby said document is visible within a portion of said selected area of the user interface display screen.

2. A method for implementing transparent scrollbars on a user interface display screen in a computer system as recited in claim 1 wherein the step of drawing said document in said window area including said selected area of the user interface display screen defined as said scrollbar includes the steps of defining a window area utilizing defined scrollbar dimensions for said selected area of the user interface display screen as said scrollbar; and drawing application information of said document covering said window area of the user interface display screen.

3. A method for implementing transparent scrollbars on a user interface display screen in a computer system as recited in claim 1 wherein the step of drawing predefined scrollbar elements within said selected area of the user interface display screen includes the step of drawing scrollbar arrow buttons for said selected area of the user interface display screen defined as said scrollbar.

4. A method for implementing transparent scrollbars on a user interface display screen in a computer system as recited in claim 1 wherein the step of drawing predefined scrollbar elements within said selected area of the user interface display screen includes the step of drawing a scroll up arrow button at a top location of said selected area of the user interface display screen defined as said scrollbar and drawing a scroll down arrow button at a bottom location of said selected area of the user interface display screen defined as said scrollbar.

5. A method for implementing transparent scrollbars on a user interface display screen in a computer system as recited in claim 4 wherein the step of drawing predefined scrollbar elements within said selected area of the user interface display screen includes the step of drawing a scroller within said selected area of the user interface display screen between said scroll up arrow button and said scroll down arrow button.

6. A method for implementing transparent scrollbars on a user interface display screen in a computer system as recited in claim 1 wherein said predefined scrollbar elements include scroll arrow buttons and a scroller and further includes the steps of checking for user clicks on a scroll arrow button, responsive to identifying user clicks on a scroll arrow button, moving said scroller toward said scroll arrow button; erasing said defined window area and drawing said document in said defined window area.

7. A method for implementing transparent scrollbars on a user interface display screen in a computer system as recited in claim 6 includes the steps of checking for user clicks between said scroll arrow button and said scroller, responsive to identifying user clicks between said scroll arrow button and said scroller, moving said scroller a maximum scroller length toward said scroll arrow button; erasing said defined window area and drawing said document in said defined window area.

8. A method for implementing transparent scrollbars on a user interface display screen in a computer system as recited in claim 6 includes the steps of checking for user dragging said scroller, responsive to identifying user dragging said scroller, erasing said defined window area and drawing said document in said defined window area.

9. Apparatus for implementing transparent scrollbars on a user interface display screen in a computer system comprising:
a transparent scrollbar program for use with a graphical user interface program, said transparent scrollbar program performing the steps of:
defining scrollbar dimensions corresponding to a selected area of the user interface display screen for a scrollbar;
defining a document window area utilizing said defined scrollbar dimensions, said document window area including said selected area of the user interface display screen for said scrollbar;
drawing a document in said defined window area; and
drawing predefined scrollbar elements within said selected area of the user interface display screen, whereby said document is visible within a portion of said selected area of the user interface display screen for said scrollbar.

10. Apparatus for implementing transparent scrollbars on a user interface display screen in a computer system as recited in claim 9 wherein said step performed by said transparent scrollbar program of drawing predefined scrollbar elements within said selected area of the user interface display screen, whereby said document is visible within a portion of said selected area of the user interface display screen for said scrollbar includes the steps of drawing scrollbar arrow buttons for said selected area of the user interface display screen defined as said scrollbar and drawing a scroller between said scrollbar arrow buttons.

11. Apparatus for implementing transparent scrollbars on a user interface display screen in a computer system as recited in claim 10 wherein said step performed by said transparent scrollbar program of drawing predefined scrollbar elements within said selected area of the user interface display screen includes the step of rendering said document visible within said portion of said selected area of the user interface display screen for said scrollbar where said predefined scrollbar elements are not drawn.

12. Apparatus for implementing transparent scrollbars on a user interface display screen in a computer system as recited in claim 10 wherein said predefined scrollbar elements include scroll arrow buttons and a scroller and wherein said transparent scrollbar program further performs the steps of checking for user entries relative to said scroll arrow buttons and said scroller; and responsive to identifying a predefined user entry, erasing said defined window area and drawing said document in said defined window area.

13. A computer program product for implementing transparent scrollbars on a user interface display screen in a computer system, said computer program product including a plurality of computer executable instructions stored on a computer readable medium, wherein said instructions, when executed by a computer, cause the computer to perform the steps of:
defining a selected area of the user interface display screen as a scrollbar;
drawing a document in a defined window area including said selected area of the user interface display screen; and
drawing predefined scrollbar elements within said selected area of the user interface display screen, whereby said document is visible within a portion of said selected area of the user interface display screen.

14. A computer program product for implementing transparent scrollbars on a user interface display screen in a computer system as recited in claim 13 wherein said instructions, when executed by said computer, further cause the computer to perform the steps of checking for user entries relative to said predefined scrollbar elements; and responsive to identifying a predefined user entry, erasing said defined window area and drawing said document in said defined window area.

15. A computer program product for implementing transparent scrollbars on a user interface display screen in a computer system as recited in claim 14 wherein said predefined scrollbar elements include a pair of scroll arrow buttons and a scroller drawn between said scroll arrow buttons and wherein said step of identifying a predefined user entry includes the steps of identifying user clicks on a scroll arrow button; and responsive to identifying user clicks on a scroll arrow button, moving said scroller toward said scroll arrow button; erasing said defined window area; and drawing said document in said defined window area.

16. A computer program product for implementing transparent scrollbars on a user interface display screen in a computer system as recited in claim 15 wherein said step of identifying a predefined user entry includes the steps of identifying user clicks between said scroll arrow button and said scroller, responsive to identifying user clicks between said scroll arrow button and said scroller, moving said scroller a maximum scroller length toward said scroll arrow button; erasing said defined window area and drawing said document in said defined window area.

17. A computer program product for implementing transparent scrollbars on a user interface display screen in a computer system as recited in claim 15 wherein said step of identifying a predefined user entry includes the steps of identifying a user dragging said scroller; and responsive to identifying said user dragging said scroller, erasing said defined window area and drawing said document in said defined window area.
